(19) United States
(12) Patent Application Publication
(10) Pub. No.: US 2009/0282733 A1
(43) Pub. Date: Nov. 19, 2009

(54) MULCH MAT WITH FERTILIZER AND REALISTIC APPEARANCE

(76) Inventors: Richard C. Moore, JR., Charleston, SC (US); Sheila B. Jones, McGregor, TX (US)

Correspondence Address: TURNER PADGET GRAHAM & LANEY, P.A., P.O. BOX 1509, GREENVILLE, SC, 29602, US

(21) Appl. No.: 12/122,038

(22) Filed: May 16, 2008

(51) Int. Cl. A01G 29/00; A01G 13/00

(52) U.S. Cl. 47/31; 47/48.5

(57) ABSTRACT

An elastomeric mat is provided, which includes rubber buffings, a binder holding the buffings together, and a coloring agent. A portion of the rubber buffings is randomly and angularly oriented, relative to the lower surface of the mat, to provide a non-uniform upper surface and a non-uniform thickness of the mat. The irregular spacing of the rubber buffings and the irregular surface texture results in a mat resembling natural shredded wood mulch. Fertilizer may also be incorporated on, or within, the mat to nurture trees or other plants about which the mat is placed.

### TECHNICAL FIELD

The present disclosure relates to the protection of trees and plants and, more particularly, to rubber mat products that provide a realistic appearance characteristic of natural mulch. Also provided herein are natural-looking, rubber mat products that include fertilizer compounds, which nurture the plants surrounded by the mat products. Processes for producing such mat products are also provided.

### BACKGROUND

To beautify lawns, gardens, and other outdoor grounds, natural mulching systems—such as natural bark, wood products, peat, pine needles, and the like—are commonly used for mulching around trees, plants, and other items. In addition to their aesthetic function, these natural mulching systems protect the root systems of the surrounded plant life from sometimes harsh environmental conditions and also inhibit weed and grass growth in the areas that have been mulched. As a result, the need for mowing or trimming in close proximity to the surrounded plant life is minimized, thereby reducing the risk that the plant life may be damaged by these activities.

Natural mulching systems have several attendant disadvantages, however. First, because the materials are natural, they tend to degrade over time due to exposure to the elements. Natural mulching elements may further be eroded by hard rains, routine watering, or wind, for example, leaving the ground thereunder subject to erosion and other environmental conditions. Consequently, the mulch systems require on-going maintenance and replenishment to ensure an adequate level of protection and to preserve a groomed appearance. Such continuing care may be expensive and cumbersome to maintain, leaving some trees or plants exposed for some period of time.

Another disadvantage of some mulching systems may be the tendency of the mulching systems themselves to absorb water, thereby preventing water from seeping through the mulching system to the underlying roots. Alternately, or in addition, some mulching systems exhibit a tendency to draw water or moisture away from the underlying roots by capillary action. In each instance, the risk of damage to the plants may be increased, if such conditions exist for a long period.

Yet another shortcoming of natural mulching systems may be that such systems provide no nutrients to the underlying roots of plants that they surround. For example, a gardener or groundskeeper may have to apply fertilizer before the mulching system is installed or with some frequency after installation. Such efforts may be ineffective or labor-intensive, especially if the mulching system is applied over an impermeable landscape sheet.

To address some of these problems, artificial mulching systems have been introduced, in which rubber or other synthetic materials are chipped or ground to a desired size and/or shape and then secured with a binder composition. One such mulching system may be found in U.S. Pat. No. 5,396,731 to Byrne. While artificial mulching systems remedy some of the deficiencies described above, many suffer from an unnatural appearance or from a lack of air and water permeability.

### SUMMARY

The present mulch mat overcomes the shortcomings of natural mulching systems and of other artificial mulch systems by providing a realistic appearing, air and water permeable, durable mat. In a first aspect, an elastomeric mulch mat is provided, which includes rubber buffings, a binder holding the buffings together, and a coloring agent. The mat features a perimeter edge, a lower planar surface, and an upper surface opposite the lower planar surface, and further features a hole therethrough from the upper surface to the lower planar surface. A slit extends from the perimeter edge to the hole to permit the mulch mat to be fitted around a plant or other object.

The rubber buffings may be randomly oriented within the mat, resulting in the angular positioning of the rubber buffings relative to the lower planar surface and in the creation of an uneven, or jagged, upper surface. The thickness of the mat, as measured from the lower planar surface to the upper surface, varies from point to point, due to the irregular texture produced by the randomly projecting rubber buffings. The rough texture and variable thickness produce an appearance characteristic of natural mulch.

According to other aspects, the mulch mat may include rubber granules, fibers, an anti-gloss agent, and/or a fertilizer compound. In those mats where a fertilizer compound is present, the fertilizer may be in granular or liquid form. The fertilizer may be primarily located on the bottom surface of the mat or may be intimately mixed with the rubber components within the mat.

The perimeter edge may define a substantially circular shape. The rubber buffings may extend beyond the perimeter edge to create a non-uniform perimeter.

In another aspect, the slit may be rejoinable to impart a seamless appearance to the mat. Further, in this aspect, the slit may be non-linear from the perimeter edge to the hole.

### BRIEF DESCRIPTION OF THE DRAWINGS

FIG. 1 is a perspective view of a flexible mulch mat shown in an intended use, according to one aspect of the disclosure;

FIG. 2 is a top plan view of the flexible mulch mat of FIG. 1;

FIG. 3A is a schematic cross-sectional view of the mulch mat, taken along line 3-3 of FIG. 2;

FIG. 3B is a perspective view of a mulch mat;

FIG. 4 is a schematic view of a manufacturing line showing a process of forming the rubber components of the present mulch mats;

FIG. 5 is a schematic view of a manufacturing line showing a process of forming the mulch mats of the present disclosure;

FIG. 6 is a schematic view of a manufacturing line showing an alternate process of forming the mulch mats of the present disclosure; and

FIG. 7 is a perspective view of a mulch mat in an intended use, showing the dissolution of fertilizer granules by rainwater and the resultant leaching of fertilizer from the mulch mat to the roots of a tree.

### DETAILED DESCRIPTION

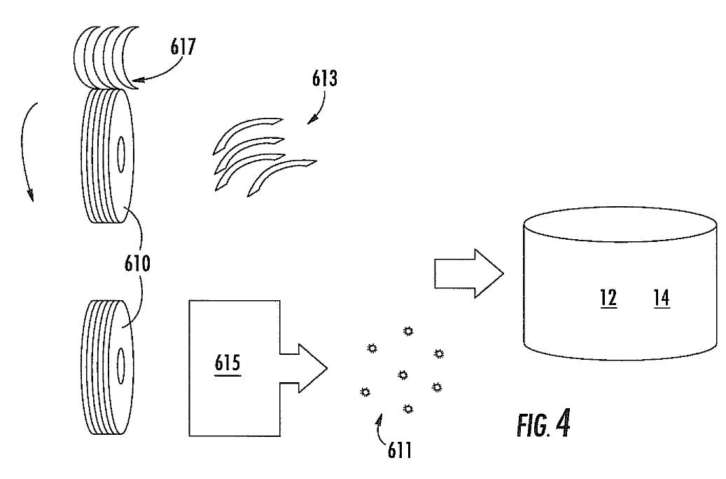

Generally, the present mulch mats (alternately, “pads”, “skirts”, or “rings”) may comprise rubber shavings and/or rubber granules that are adhered together by a binder. The rubber shavings and/or rubber granules may be obtained by chipping, cutting, or chopping used tires or other recyclable rubber, or synthetic materials, into rubber components 12, which are made to appear as wood chips, wood shreds, wood nuggets, pebbles, stones, pine needles, or other natural materials. Such process will be described below, in reference to FIGS. 4-6.

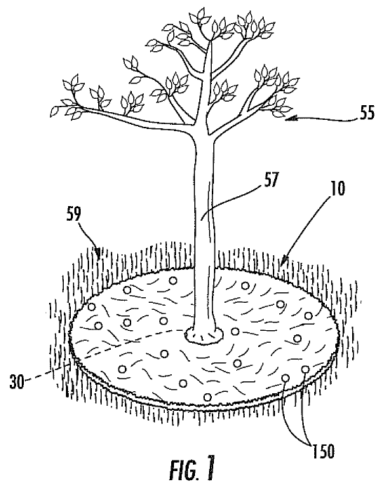

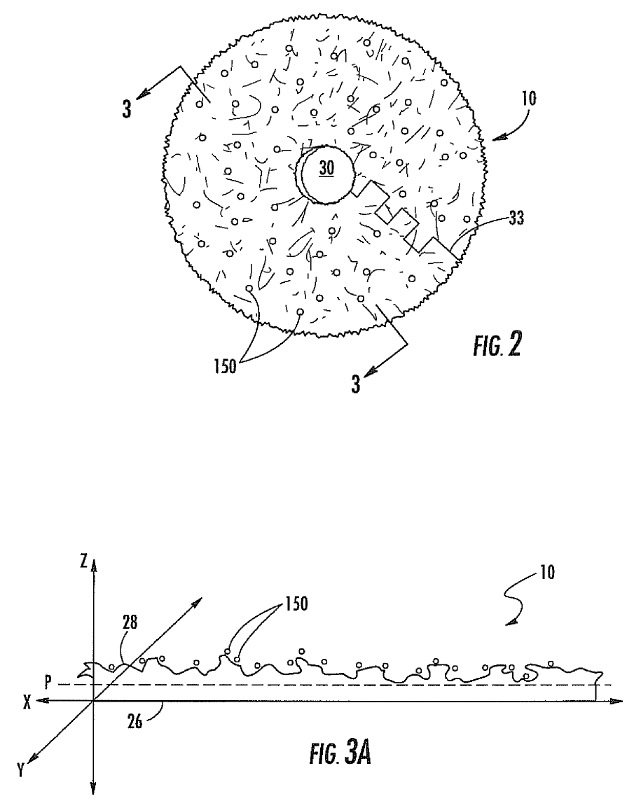

Turning now to FIG. 1, a representative use of a mulch mat, according to the present disclosure, is shown, in which a mulch mat 10 is place around a tree 55 or other plant. The mulch mat 10 is generally circular in shape and includes a centrally located hole, or aperture, 30, which is placed around the tree trunk 57. A slit (shown in FIG. 2) permits the mulch mat 10 to be positioned properly around the trunk 57. Optionally, the mulch mat 10 may include fertilizer disposed about the rubber components comprising the mat 10. As shown, the fertilizer may be in the form of granules 150, although the fertilizer may instead be incorporated in liquid form into the mat structure. The mulch mat 10 provides a protective border around the tree 55, preventing grass 59 from growing too close to the trunk 57 and thereby reducing the likelihood of the tree being damaged from mowers, flexible line trimmers, edgers, and the like.

FIG. 2 shows the mulch mat 10 from the top surface, optionally, including fertilizer granules 150. A liquid fertilizer may be incorporated into the mulch mat 10, as the fertilizer component, either in addition to or in place of the fertilizer granules 150. In either liquid or granule form, the fertilizer may be localized on or near one surface (as shown in FIG. 2) or may be dispersed throughout the structure.

Notably, although the mulch mat 10 is generally circular in shape, the upper surface of the mulch mat 10 features an irregular (i.e., non-uniform) perimeter. Such perimeter results from the random and angular orientation of the rubber components, resulting in an irregular arrangement and an irregular spacing between the rubber components. Further, this irregular spacing leads to voids between the rubber components, thereby creating passageways for water to flow through the mulch mat 10 and for moisture to evaporate upward from beneath the mulch mat 10. While the mat 10 is shown in a generally circular shape, other shapes having curved or straight sides may also be manufactured to meet user preferences.

A hole, or aperture, 30 may be centrally located within the mulch mat 10, though other placements may be possible as needs dictate. As shown in FIGS. 1 and 2, the hole, or aperture, 30 may be circular in shape. However, the hole 30 may be formed or cut into any suitable or desired shape, such as a square, for instance, in the event that the mulch mat is to be placed around a square-shaped post. In the event that the hole or aperture 30 is too small to fit around the trunk of the tree or plant to be protected, the mulch mat 10 may be cut by the user to remove an additional portion of the mulch mat 10. The mulch mat 10 is sufficiently pliable to permit cutting.

A slit 33 may be cut from the hole 30 to the perimeter edge, such that the mulch mat 10 may be fitted around a tree trunk, as shown in FIG. 1, or some other object. According to one practice, the slit 33 may be cut from the bottom surface of the mulch mat 10, using any suitable means, such as a heated wire cutter. By stopping short of the upper surface, uncut areas remain, which facilitate handling before installation. In addition, the tearing of the mulch mat 10 along the slit 33 results in an uneven appearance along the upper surface of the mulch mat 10, further enhancing its resemblance to natural mulch.

As shown in FIG. 2, the pre-formed slit 33 may have a tortuous or serpentine shape, which is relockable by virtue of interlocking members formed when the mulch mat 10 is torn along the slit 33. Alternately, the slit 33 may be a linear, or straight, slit. As described above, the uneven edges along the upper surface of the mat 10, when locked together around a tree or plant, produce the visual appearance of a continuous natural surface.

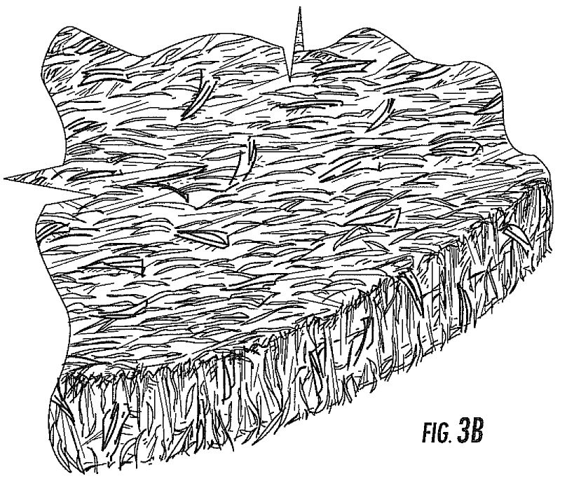

A schematic cross-section of the mulch mat 10 of FIG. 2 is shown in FIG. 3A. The mat includes rubber components (shavings and/or granules), which are held together with a binder material. Additionally, fertilizer granules 150 may be disposed about the rubber components, either throughout the mat or disposed proximate to one surface of the mat.

As represented in FIG. 3A, the lower surface 26 of the mulch mat 10 may be described as occupying a plane defining an x-axis and a y-axis. The rubber buffings are randomly oriented and occupy various angular positions relative to the lower planar surface. Said differently, the rubber buffings may be affixed in an irregular arrangement, in which the buffings extend, or project, at a variety of angles (i.e., in the “z”-direction) relative to the lower planar surface (i.e., the “x-y” planes. As may also be seen from FIG. 3A, the thickness of the mat varies from point to point across the mat, due to the unpredictable array of the rubber components above centrally located transverse plane P, which parallels the lower planar surface.

FIG. 3B provides a perspective view of the irregular mass of rubber components that produce the present mulch mats. A portion of the rubber components project from the upper surface, resulting in a non-uniform, rough texture and a realistic appearance. The angular orientation of the rubber buffings within the mat forms an interlocking matrix that enhances the structural integrity of the mat. The use of rubber components of different sizes further contributes to the random contours of the mat and to the creation of non-linear channels throughout the body of the mat for water and moisture transport. As discussed above, the varying thicknesses across the “x-y” plane impart a desirable mulch-like quality.

The mulch mat 10 may include rubber shavings or buffings 613 and may also include rubber granules 611 (which are shown in FIG. 4), collectively referred to herein as the rubber components 12. As shown in FIG. 4, the rubber components 12 may be obtained from used tires 610, which are processed to produce rubber shavings or buffings 613 and/or rubber granules 611.

The rubber components may be derived from used tires or retread pieces, although other rubber sources may be used instead of, or in conjunction with, tires. The shavings or granules may be made of any of various types of rubber, including acrylonitrile-butadiene rubber (NBR), styrene-butadiene rubber (SBR), carboxylated NBR, chlorinated rubber, silicone containing rubber, EPDM and the like. Alternately, the shavings 613 or granules 611 may be made of an elastomer material other than rubber.

When the used tires 610 or retread pieces are ground in a granulator 615, steel or other fiber components are removed, leaving rubber granules 611. Obviously, other rubber or elastomeric sources may not include fiber or other reinforcing constituents. The resulting rubber granules are generally in the range of about ⅛ inch to about ¾ inch in major dimension. The granulator 615 may be adjusted to produce granules of different dimensions, and granules having different dimensions may be used in the same mulch mat.

In one construction, the majority of the rubber components of the mulch mat are rubber shavings or buffings, which may be made to resemble wood shreds or chips and which provide relatively more strength and flexibility to the mat 10. To produce such shavings, or buffings, 613, a buffing machine 617 is rotated about the tire 610 (or vice versa) to shed the buffings 613. The rubber shavings, or buffings, are characterized as having a length greater than their width (e.g., about ¼ inch to about 3 inches in length and about ⅛ inch to about 1 inch in width). According to one aspect provided herein, the shavings 613 and/or granules 611 are of non-uniform size and shape to enhance the natural appearance of the mulch mat 10.

Rayon, nylon, polyaramid, or other such materials may be used to reinforce the tires 610, in which case the discrete fibers of such materials may also be the byproduct of shredding, mulching, granulating, or buffing the tires 610. Such fibers may have a length of about 1 inch. Optionally, these fibers 14 may be included with the rubber components 12 in the manufacturing process.

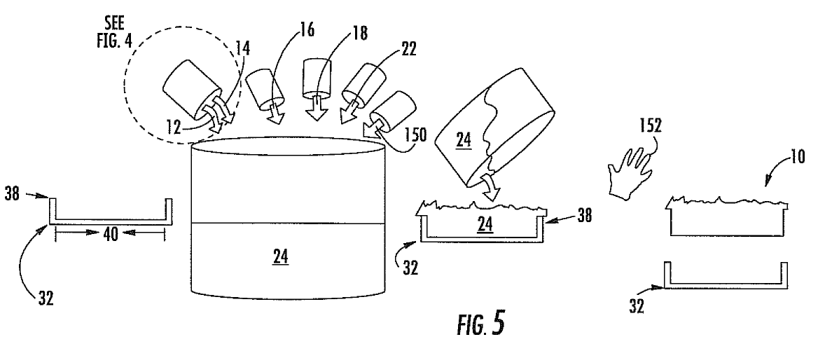

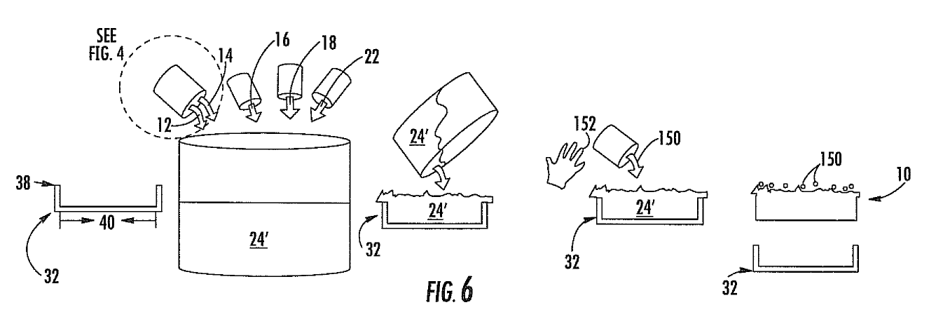

The rubber components are held together by a curable binder (shown as 16 in FIGS. 5-6). The binder 16 may be a latex or a urethane binder, such as moisture-curable polyurethane. Binders other than polyurethane (e.g., polyacrylates) may instead be used to adhere the rubber components 12.

To provide a natural appearance to the rubber components, coloring agents 18 may be incorporated into the mulch mat 10 (as shown in FIGS. 5 and 6). The coloring agent may be a pigment, such as an iron oxide pigment. The coloring agent(s) 18 may further include an anti-gloss agent or compound to minimize sheen or gloss. Diatomaceous silica may be used as anti-gloss agent. The diatomaceous silica, for instance, may be sprinkled on the surface of the uncured, molded mixture to reduce gloss.

As described with reference to FIGS. 5 and 6, the mulch mat mixture 24, 24′ may further include a catalyst 22. The catalyst may be chosen based on the type of binder system being used.

In some instances, it may be desirable to incorporate a fertilizer compound into the mulch mat 10. The fertilizer 150 may be organic, inorganic, or a combination of organic and inorganic components. Moreover, the fertilizer 150 may be granular, a powder, a liquid, a slow-release fertilizer, and combinations of these and other fertilizer types. Further, the fertilizer 150 may be added during the mat formation process (as shown in FIG. 5) or after the mat formation process (for example, as shown in FIG. 6). The fertilizer 150 may also be added to the mat 10 after use for a period of time to replenish the fertilizing properties of the mat 10.

Turning now to FIG. 5, a mold 32 is provided for making the mulch mat 10. The mold 32 has an inner diameter 40 and an upper edge portion 38. A mixture 24 is produced by mixing the rubber components 12, (optionally) the fibers 14, a binder 16, a coloring agent 18, a catalyst 22, and, in one embodiment, a fertilizer 150 in a mixing vessel. The resultant mixture 24 is weighed and placed into the mold 32. If necessary, the upper surface may be manually leveled, as schematically depicted by a hand symbol 152, to form an irregular surface. As shown, the mixture 24 is allowed to extend beyond the upper edge 38 of the mold 32, creating an uneven and jagged surface texture on the upper surface of the mat 10. Using this manufacturing process, the fertilizer 150 is disposed throughout the mat 10, rather than being concentrated in one area of the mat.

By way of example, the mixture 24 may contain, by weight, from about 75% to about 88% rubber components 12; from about 0% to about 2% fiber 14; from about 10% to about 15% binder 16; from about 2% to about 5% coloring agent 18 (based on the total weight of the binder); from about 0.01% to about 0.03% catalyst 22 (based on the total weight of the binder); from about 1% to about 10% fertilizer 150; and a negligible percent of UV light stabilizers and anti-oxidants.

When making a mat having the appearance of shredded wood mulch, the rubber component may be made entirely of rubber buffings 613. However, when making a mat having the appearance of pebbles or stones, the rubber component may be made entirely of rubber granules 611. Combinations of rubber granules 611 and rubber buffings 613 may also be used to create a varied texture in the mulch mat.

FIG. 6 shows an alternate process for making a fertilizer-treated mat 10. Again, a mold 32 is used, which has an upper perimeter edge 38 and an inner diameter 40. In this process, a mixture 24′ is produced by combining the rubber components 12, (optionally) the fibers 14, a binder 16, a coloring agent 18, and a catalyst 22. The resultant mixture 24′ is weighed and placed into the mold 32. If necessary, the upper surface may be manually leveled, as schematically depicted by a hand symbol 152, to form an irregular surface. As before, the mixture 24′ is allowed to extend beyond the upper edge 38 of the mold 32, creating an uneven and jagged surface texture on the upper surface of the mat 10. At this point, a fertilizer compound 150 may be added to the upper surface of the mat 10, thereby concentrating the fertilizer in one area of the mat 10. Although shown as being added to the upper surface of the mat, it may be desirable, in some applications, to apply the fertilizer compound 150 to the ground-contacting side of the lower planar surface, in which case the mat 10 would be turned over (i.e., with the upper surface facing downward) before application of the fertilizer compound 150.

By way of example, the mixture 24′ may contain, by weight, from about 75% to about 88% rubber components 12; from about 0% to about 2% fiber 14; from about 10% to about 15% binder 16; from about 2% to about 5% coloring agent 18 (based on the total weight of the binder); from about 0.01% to about 0.03% catalyst 22 (based on the total weight of the binder); and a negligible percent of UV light stabilizers and anti-oxidants. The add-on weight of the fertilizer may be from about 1% to about 10% of the weight of the mat.

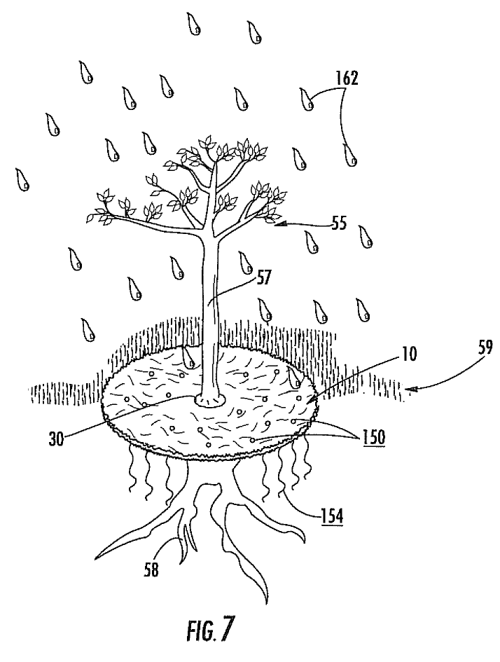

FIG. 7 shows the mulch mat 10 to which fertilizer granules 150 have been applied. As rain or water 162 contacts the fertilizer 150, the fertilizer 150 activates, such as by becoming a liquid 154, and passes through the mat 10 to nourish the tree roots 58. Also as shown, the mat 10 is sufficiently porous to permit the liquid 154 to pass through to the tree roots, but is sufficiently dense to prevent weeds, grass, and other undesired plant life from growing through the mat 10. It will be appreciated that, although fertilizer 150 is depicted as granules on the upper surface of the mat 10, the fertilizer 150 may be embedded in various portions of the mulch mat. Alternately or additionally, the fertilizer 150 may be in the form of a liquid that is incorporated into the mixture 24 to form the mat 10.

Once the fertilizer 150 is depleted, perhaps after a season of use, the user may replenish the fertilizer 150 by sprinkling or spraying new fertilizer onto the upper surface of the mat, from which the newly applied fertilizer will leach or seep into the underlying roots, as described above.

Although reference has been made to the use of the present mulch mats around trees, it should be understood that the mat may be used around foliage other than trees (such as shrubs), or around posts or poles (such as mailbox posts, light poles, and other inanimate objects) to protect wooden or painted surfaces. Obviously, in the event that the mat is to be used around a non-living object, a fertilizer compound is unnecessary.

In use, the mulch mat 10 appears as a natural mulch-covered area. The mulch mat 10 is sufficiently durable to withstand various weather conditions and lasts many times longer than natural mulch, which tends to fade, decompose, and become scattered, due to wind, rain, and foot traffic. The mulch mat 10 provides protection to trees and plants, preventing weed or grass growth adjacent to the trees or plants and preventing incidental damage from mowers or trimmers. Additionally, the fertilizer-treated mulch mats 10 beneficially nurture trees or plants, as fertilizer leaches through the mat's lower surface and into the root system of the trees or plants.

We claim:

1. An elastomeric mat comprising:
rubber buffings;
a binder holding the rubber buffings together in the form of a permeable mat; and
a coloring agent combined with at least one component of the mat;
the mat having a perimeter edge, a lower planar surface, and an upper surface opposite the lower planar surface, and further having a hole therethrough from the lower planar surface to the upper surface and a slit extending from the perimeter edge to the hole;
a portion of the rubber buffings being randomly and angularly oriented within the mat and extending from the lower planar surface, the randomly and angularly oriented buffings imparting a non-uniform texture to the upper surface of the mat and a non-uniform thickness to the mat.

2. The mat of claim 1, further comprising rubber granules.

3. The mat of claim 1, further comprising fibers.

4. The mat of claim 1, further comprising an anti-gloss agent.

5. The mat of claim 1, wherein the perimeter edge defines a substantially circular shape.

6. The mat of claim 5, wherein the randomly and angularly oriented buffings extend beyond the perimeter edge of the upper surface of the mat to create a non-uniform perimeter.

7. The mat of claim 1, further comprising a fertilizer compound.

8. The mat of claim 7, wherein the fertilizer compound is in granular form.

9. The mat of claim 7, wherein the fertilizer compound is in liquid form.

10. The mat of claim 7, wherein the fertilizer compound is primarily located on the bottom of the lower planar surface.

11. The mat of claim 7, wherein the fertilizer compound is intimately mixed within the mat.

12. The mat of claim 1, wherein the slit is rejoinable to impart a seamless appearance to the mat.

13. The mat of claim 12, wherein the slit is non-linear from the perimeter edge to the hole.
